(19) United States
(12) Patent Application Publication
(10) Pub. No.: US 2004/0076721 A1
(43) Pub. Date: Apr. 22, 2004

(54) Containers with peelable closures that change appearance upon bending

(76) Inventors: Aron M. Rosenfeld, Palo Alto, CA (US); Melville Douglas Ball, Kingston (CA); Edmund T. Gillest, Batavia, IL (US); Gary J. Smith, Glenburnie (CA)

Correspondence Address: Christopher C. Dunham, c/o COOPER & DUNHAM LLP, 1185 Avenue of the Americas, New York, NY, 10036, US

(21) Appl. No.: 10/273,737

(22) Filed: Oct. 18, 2002

(51) Int. Cl. A23L 1/00

(52) U.S. Cl. 426/87

(57) ABSTRACT

A metal can for holding a carbonated or otherwise pressurized beverage or the like, having a rigid metal lid formed with an aperture, and a flexible closure member extending over the aperture and peelably bonded to the lid, the closure member including a portion that undergoes an irreversible change in appearance upon bending and is disposed to be bent by peeling of the closure.

### BACKGROUND OF THE INVENTION

This invention relates to containers, for beverages and the like, having flexible, peelable closures that undergo an irreversible change in appearance upon bending, and to container components bearing such peelable closures, as well as to methods and systems of producing and using these containers.

In an important specific aspect, to which detailed reference will be made herein for purposes of illustration, the invention is directed to beverage cans having apertured lids with flexible, peelable members closing the apertures, and in particular to cans that are subjected to substantially elevated internal pressure such as cans of carbonated beverages.

Beverages are commonly packaged in cans having lids with apertures for drinking and/or pouring. In some instances the aperture is covered by a flexible closure sealingly adhered to the lid around the aperture rim and removable by peeling. As a protection against tampering with the contents of a beverage can by peeling and reapplying a flexible closure, so-called tamper-evident features activated by peeling may be included in the can and/or closure to provide an indication that the closure has been disturbed. Examples of tamper-evident features (typically involving a change in color, prevention of re-adherence of a closure, and/or the emergence of a pattern or legend) are described in U.S. Pat. Nos. 3,896,965; 4,537,327; and 4,837,061. In particular, U.S. Pat. No. 5,282,650, the entire disclosure of which is incorporated herein by this reference, describes a flexible color change device which undergoes an irreversible color change on bending, owing to detachment of layers of oxide and metal that, when in intimate contact, generate a visible color by light interference and absorption effects. A further type of tamper-evident device, described in U.S. Pat. No. 5,218,472, the entire disclosure of which is also incorporated herein by this reference, is exemplified by a metal-oxide-metal optical interference structure with a weakened stratum at which the structure can be fractured and separated so as to cause a visible color change.

Heretofore cans with pressurized contents, such as cans of carbonated beverages, have ordinarily not had apertures with peelable closures, owing to the difficulty of both preventing burst failure of the closure (when subjected to the elevated pressure within the can) and at the same time providing a sufficiently low peel force to enable manual removal of the closure. Thus, in present-day commercially available carbonated soft drink cans, having a drawn-and-ironed aluminum alloy can body and an aluminum alloy can lid peripherally secured thereto, the can end is typically formed with a scored line and provided with a riveted tab system which, when lifted, exerts a downward force by lever action that generates a fracture along the scored line and simultaneously bends down a region of the lid within the scored line to create an aperture for drinking or pouring. The readily detectable and irreversible destruction of can lid integrity effected by any fracture of the scored line inherently affords an indication of tampering that precludes any need for tamper-evident features.

Notwithstanding the widespread use of scored area riveted tab opening systems for carbonated beverage cans, the use of a flexible, peelable closure for these cans offers advantages with respect to one or more of various considerations including cost, vulnerability to corrosion, and hygiene. Copending U.S. patent application Ser. No. 10/150,683, filed May 17, 2002, the entire disclosure of which is incorporated herein by this reference, and which is assigned to the same assignee as the present application, describes such a can, including a substantially rigid metal can lid secured at its periphery to and closing the open upper end of a can body; an upwardly projecting annular flange formed in a portion of the lid and having an upwardly sloping outer surface and an annular inner edge lying substantially in a plane and defining an aperture; and a flexible closure member of a material comprising a metal foil, extending entirely over the aperture and peelably bonded by a heat seal to the flange outer surface entirely around the aperture. When the can is filled with a carbonated beverage, the closure member is subjected to a positive pressure differential (between the pressure within the can and ambient pressure outside the can) which exerts forces on the closure member and heat seal, producing distortion (including upward bulging) of the closure member; but the average diameter of the aperture, the angle of slope of the flange, and the deformability of the closure member material are mutually selected such that the closure member, when subjected to the aforesaid pressure differential, bulges upwardly with an arc of curvature such that a line tangent to the arc at the inner edge of the flange lies at an angle (to the plane of the flange inner edge) not substantially greater than the angle of slope of the flange outer surface, thereby to eliminate any peel component of the force exerted by the differential pressure on the closure member and heat seal.

### SUMMARY OF THE INVENTION

An object of the invention is to provide a tamper-evident feature in a can of the type just described, having pressurized contents and a peelable closure member. A further object is to provide such a feature in a way that avoids or overcomes the problem that distortion of the closure member incident to pressurization of the can may itself prematurely activate the same tamper-indicating change of appearance as actual bending and/or peeling of the closure, vitiating the effectiveness of the change of appearance as a sign of tampering. Yet another object is to provide promotional functions or uses for appearance-changing features of peelable container closures.

To these and other ends, the present invention, in a first aspect, broadly contemplates the provision of a beverage package comprising a can including a body having an open upper end and a substantially rigid lid secured at its periphery to and closing the body end, the lid having an upper surface and defining an aperture; a quantity of a carbonated, or otherwise pressurized, beverage contained within the can; and a flexible closure member extending entirely over the aperture and peelably bonded to the lid upper surface entirely around the aperture, wherein the closure member includes a portion that undergoes an irreversible change in appearance upon bending by peeling of the closure member.

The package may be produced by successive steps of applying and bonding the closure member to the lid upper surface, filling the can body with the beverage and then closing the open upper end of the can body by securing the lid thereto with the closure member already bonded to the upper surface, wherein a first region of the closure member undergoes distortion during performance of these steps while a second region of the closure member undergoes at least substantially less distortion than said first region.

In certain embodiments of the invention, the appearance-changing portion is provided in the closure member before the lid is secured to the body but does not undergo any observable change in appearance upon distortion of the closure member. For example, the appearance-changing portion may be disposed in at least part of the second region but not in the first region of the closure member, so as not to be subjected to the extent of distortion imparted to the first region, thereby avoiding premature activation of the change in appearance induced by peeling. Alternatively, the appearance-changing portion may be disposed in both of the first and second regions of the closure member, and the closure member may bear a printed overlay masking the appearance-changing portion in the first region but not in the second region, thereby to conceal any prematurely activated change in appearance in the first region.

Preferably, in these embodiments, the appearance-changing portion covers between about 15% and about 75% (more preferably, between about 35% and about 55%) of the upwardly-facing surface area of the closure member.

In other embodiments, the appearance-changing portion is added to the closure member only after the lid is secured to the can body, so as not to be prematurely activated by the distortion of the closure member that occurs during performance of the aforementioned successive steps. Such an appearance-changing portion may comprise flexible web material adherently applied to at least part of the closure member (e.g., two or more separate strips of the flexible web material) and preferably covers between about 5% and about 50% (more preferably, between about 15% and about 35%) of the upwardly-facing surface area of the closure member.

The invention also embraces methods of producing a package of a carbonated or otherwise pressurized beverage, having a peelable closure member with a portion that undergoes an irreversible change in appearance upon bending by peeling of the closure member, comprising the aforementioned successive steps and including provision of the appearance changing portion.

Further, in currently preferred embodiments of the invention the appearance-changing portion is a color-changing device as described in the aforementioned U.S. Pat. No. 5,282,650, comprising a flexible substrate comprising a color generating metal at a first surface and an optically thin anodic film on the color generating metal intimately contacting the first surface of the substrate and generating an interference color, the device having at least one area of the first surface in which the anodic film is attached to the color generating metal with a strength of attachment falling within a range allowing the interference color to be changed in at least that one area by bending the device. Typically or preferably, the anodic layer is covered by a flexible layer of transparent or translucent material and the color generating metal is selected from the group consisting of tantalum and niobium.

Alternatively, the appearance-changing portion may be an optical interference structure as described in the aforementioned U.S. Pat. No. 5,218,472, e.g. comprising a reflective substrate, a porous dielectric film on the reflective substrate and having an outer surface opposite thereto, at least one semi-transparent reflective layer supported by the porous dielectric film, the structure having at least two reflective surfaces separated by an optically thin porous layer of the dielectric film, one of these surfaces being present at the outer surface of the film, and the structure having a weakened stratum in the porous film between the outer surface and the substrate, the position of the stratum being such that, upon separation of the film along the stratum, a change of color is observed.

Stated somewhat more generally, the appearance-changing portion may comprise at least two contiguous but separable layers, one overlying the other, and characterized by a first apparent color that changes irreversibly to a second color, visually distinguishable from the first color, upon separation of the layers. The layers, in at least part of the appearance-changing portion, may separate upon bending of the closure member. The appearance-changing portion may further comprise an agent that alters the resistance of the contiguous layers to separation; for particular purposes, the agent is provided in a pattern such that upon bending, the contiguous layers separate, to produce a change from the first color to the second color, in accordance with the pattern, thereby making the pattern visible.

In other embodiments, with an appearance-changing portion comprising contiguous but separable layers as aforesaid, the portion may further include a manually peelable transparent member adherently superposed on the overlying one of the layers such that peeling of the transparent member effects separation of the layers producing a change from the first color to the second color, the closure member being peelable to open the aperture only after peeling of the transparent member.

The invention in a further aspect contemplates the provision of a can lid of a type described in the aforementioned copending application Ser. No. 10/150,683, mountable on a metal can body having an open upper end so as to be secured at its periphery to (and to close) the can body end, the lid comprising a substantially rigid unitary metal can lid member having an upper surface with an annular flange formed in a portion of the lid and projecting upwardly from the lid upper surface, the flange having an upwardly sloping outer surface and an annular inner edge lying substantially in a plane and defining an aperture; and a flexible metal foil closure member extending entirely over the aperture and peelably bonded by a heat seal to the flange outer surface entirely around the aperture, wherein the closure member includes a portion that undergoes an irreversible change in appearance upon bending, the last-mentioned portion being disposed to be bent by peeling of the closure member. The invention also embraces a can comprising a metal can body having an open upper end, and a can lid as just described (including the aforesaid closure member and appearance-changing portion), secured at its periphery to and closing the can body end. Additionally, the invention embraces the provision of a carbonated, or otherwise pressurized, beverage package comprising such a can containing a body of a carbonated, or otherwise pressurized, beverage.

Apart from providing tamper-evident security, color- or other appearance-changing devices provided in or with a peelable closure can be beneficial for promotional purposes. For example, they may provide a pleasing and/or attention-attracting design or legend that appears upon opening the can and reinforces brand identification; or they may serve to designate winners of promotional contests, wherein one or a small number of cans with a hidden closure legend such as “WINNER” that appears only on peeling the closure are seeded among a much larger number of cans lacking that legend, the purchaser of the “WINNER” can being entitled to claim a prize. In such a contest, the closures of non-winning cans may be provided with appearance-changing features (also activated by peeling) that either bear a different legend or design or merely exhibit a uniform color change with no legend. By imparting appearance change to the closures of all cans involved in a promotional contest, with a differentiation in design or legend for the winning can(s), the appearance-changing feature is able to serve a tamper-indicating purpose as well as functioning to identify the winner or winners of the contest.

To this end, in yet another aspect the invention contemplates the provision of an array of cans each having an aperture closed by a peelable closure member including a portion that undergoes an irreversible change in appearance upon bending, the array comprising at least two cans respectively having closure members that are indistinguishable from each other before bending and are visibly different in appearance from each other after bending. Typically, one or at most a small number of the cans have a closure member portion that, when peeled, changes to an appearance (for example, a legend or design) indicative of a contest winner, while the great majority of the cans in the array have a closure member portion that becomes transparent (showing the color of the underlying background) or changes to a solid color (different from its initial color) when peeled.

Further features and advantages of the invention will be apparent from the detailed description hereinbelow set forth, together with the accompanying drawings.

### BRIEF DESCRIPTION OF THE DRAWINGS

FIG. 1 is a perspective view of a can embodying the present invention in a particular form;

FIG. 2 is an enlarged and somewhat simplified fragmentary elevational sectional view of a portion of the lid member of the can of FIG. 1, including the aperture-defining flange and closure member;

FIG. 3 is a view similar to FIG. 2 of a flexible closure member bonded to a conventional planar flange defining an aperture;

FIG. 4 is a fragmentary view similar to FIG. 3 of a portion of the flange and closure member of the embodiment of the invention shown in FIG. 2;

FIG. 5 is a simplified and somewhat schematic top plan view of the can of FIG. 1;

FIG. 6 is an exploded diagrammatic elevational sectional view of the can lid and closure member of FIG. 5;

FIG. 7 is a plan view of the closure member of FIG. 5;

FIG. 8 is an enlarged fragmentary sectional elevational view of a portion of the lid member of the can of FIG. 1;

FIG. 9 is a schematic fragmentary sectional elevational view of the lid member;

FIG. 10 is a cross-sectional view of a portion of the closure member of the can of FIG. 1 that undergoes an irreversible color change upon bending incident to peeling of the closure member;

FIG. 11 is a view similar to FIG. 10 but showing the area of the bend at which color activation takes place, on a slightly larger scale;

FIG. 12 is a plan view of the closure member illustrating areas or regions thereof subject to greater or less distortion incident to forming and applying the closure member to the lid and/or subjecting the closure member to pressure within the can;

FIG. 13 is a plan view of another closure member of an embodiment of the invention, wherein the portion that undergoes irreversible change upon bending is applied after the lid with the closure member is secured to the can body; and

FIG. 14 is a plan view of a closure member similar to that of FIG. 12 showing a legend that appears on the closure member upon bending.

### DETAILED DESCRIPTION

The invention will be described, with reference to the drawings, as embodied in a beverage package including a metal can 10 of a type described in the aforementioned copending application Ser. No. 10/150,683, containing a quantity (not shown) of a carbonated beverage such as soda or beer. The can 10 includes a one-piece can body 11 constituting the bottom 12 and continuous, upright, axially elongated, generally cylindrical side wall 14 of the can, and a lid 16 which, after the can has been filled with the beverage, is peripherally secured to the open top end of the can body to provide a complete, liquid-tight container.

In this can, the body 11 may be (for example) an entirely conventional drawn-and-ironed aluminum alloy can body, identical to can bodies currently commercially used for carbonated and other beverages (the terms “aluminum” and “aluminum alloy” are used interchangeably herein to designate aluminum metal and aluminum-based alloys). The bottom 12 of the body 11 is externally concave and the open top end of the body has a circular edge 18 lying in a plane perpendicular to the vertical geometric axis of the side wall 14.

Except as specified below, the lid 16 may be a generally conventional aluminum alloy lid member of the type heretofore commercially used for beverage cans having drawn and ironed one-piece can bodies such as the body 11. Thus, the alloy of which it is constituted, the steps and procedures employed in its fabrication (with exceptions noted below), and its general overall configuration, dimensions, gauge and surface coatings as well as the manner in which it is secured to the top edge 18 of the can body 11, may all be the same as in the case of conventional can lids well-known in the art. However, the lid 16 is not subjected to the rivet-forming and scoring operations that must be performed on heretofore conventional can lids; hence the strength and rigidity necessary for the conventional rivet and tab area to withstand the lever action are not required, and gauge and strength requirements related to the presence of a score line do not apply, so that the lid may use nonconventional can lid alloys, materials and/or lid gauges.

In particular, the lid 16 is substantially rigid, and has a substantially flat upper surface 20 with a circular periphery, around which is formed a raised annular rim 22 projecting upwardly above the plane of the flat upper surface 20. When the lid is mounted on the open upper end of a beverage-filled can body, in known manner, the rim 22 engages the upper edge 18 of the can body; the circular flat surface 20 lies substantially in a horizontal plane, perpendicular to the vertical geometric axis of the cylindrical side wall 14, and is centered with respect to the latter axis.

The lower end 14a of the side wall 14 of the can 10 is shaped (tapered) to interfit with the rim 22 of the lid of another identical can, when the cans are stacked vertically one on top of another. The elevation of the lid rim 22 above the flat upper surface 20 of the lid, together with the concavity of the can bottom 14, cooperatively define a central gap or space between the lid of one can and the bottom of the next can above it, in such a stacked arrangement.

The lid 16, when secured to the beverage-filled can body, provides therewith a complete sealed enclosure holding the beverage, and is thus subjected to elevated internal pressure within the can (i.e., pressure higher than ambient atmospheric pressure) if the beverage is carbonated. However, the formed aluminum alloy lid is substantially rigid, so that it undergoes at most only a small deflection of its upper surface as a result of this pressure condition, and the upper surface 20 remains substantially flat notwithstanding the internal pressure acting on the lid.

The lid 16 is arranged to provide an aperture through which the beverage contained in the can may be poured or removed by drinking directly from the can, either with a straw inserted through the aperture or by juxtaposition of the consumer's mouth to the aperture. Heretofore, in cans for holding carbonated beverages or other such contents at elevated pressure, the aperture-providing feature has conventionally included a scored portion of the metal of the lid member and a riveted pull tab system for parting the lid metal along the score line to open the aperture.

The lid 16, in contrast, has a pre-formed open aperture 24 and a peelable, flexible closure member 28 covering the aperture. In order to achieve adequate burst resistance without requiring excessive force to peel the closure member, a shallow upwardly projecting annular flange 30 is formed in the lid within the area of the flat upper surface 20, to surround and define the aperture 24 and to provide a seat for the closure member. For purposes of illustration, the flange 30 and its counterparts in other embodiments of the invention hereinbelow described are shown as frustoconical (i.e., having straight-sided upwardly sloping outer surfaces), but it is to be understood that the upwardly sloping outer surface of such a flange may alternatively be a curved sloping surface.

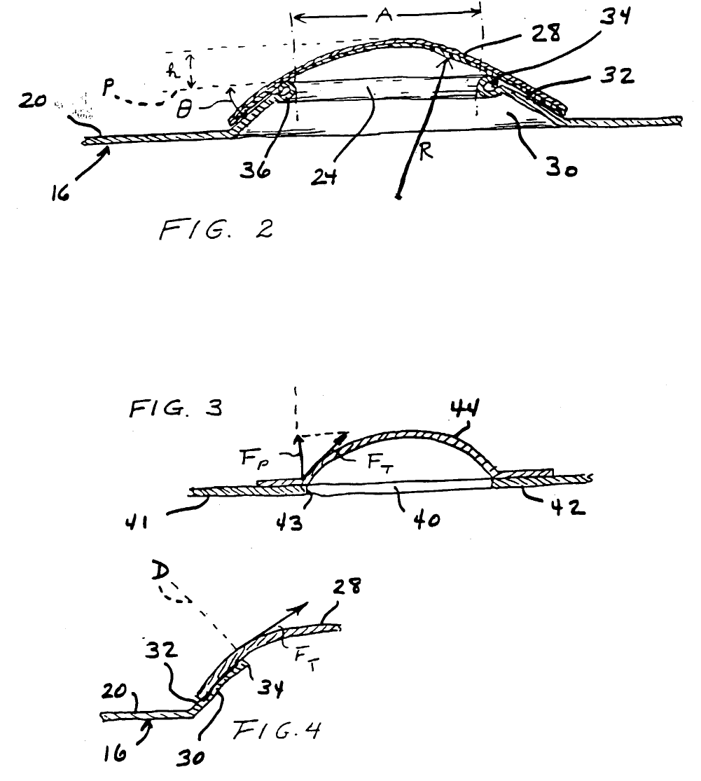

More particularly, the flange 30 projects upwardly from the upper surface 20 of the lid, and has an upwardly sloping outer flange surface 32 and an annular inner edge 34 defining the aperture 24, which is illustrated as being of circular configuration but is not limited to a circular shape. The inner edge 34, as shown in FIG. 2, is preferably formed as a bead 36 with a reverse curl, which is tangent to a horizontal plane represented by line P and to the line of slope of the outer flange surface 32 so that, once the closure member 28 is heat-sealed to the flange surface, the cut metal (typically an aluminum alloy) at edge 34 cannot come into contact with the contained beverage. This is advantageous because the cut metal at the edge (unlike the major surfaces of the lid) has no protective coating, and would be attacked by acidic or salt-containing beverages if it were exposed thereto. The reverse curl of bead 36 also prevents a drinker's lips from touching and being injured by the cut metal at edge 34, and avoids any possibility of damage to the closure member by contact with the cut metal.

The flexible closure member 28 may be constituted of a sheet material comprising metal foil, e.g. a suitably lacquered aluminum foil sheet or an aluminum foil-polymer laminate sheet. Stated more broadly, materials that may be used for the closure member include, without limitation, lacquer coated foil (where the lacquer is a suitable heat seal formulation); extrusion coated foil (where the polymer is applied by a standard or other extrusion coating process); the aforementioned foil-polymer laminate, wherein the foil is laminated to a polymer film using an adhesive tie layer; and foil-paper-lacquer combinations such as have heretofore been used for some low-cost packaging applications.

The closure member extends entirely over the aperture 24 and is secured to the flange outer surface 32 by a heat seal extending at least throughout the area of an annulus entirely surrounding the aperture. Since the reverse curl bead 36 does not project beyond the slope of the flange outer surface, the closure member smoothly overlies this bead as well as the flange outer surface, affording good sealing contact between the closure member and the flange.

The closure member is bonded by heat sealing to the flange 30, covering and closing the aperture 24, before the lid member 16 is secured to a can body 11 filled with a carbonated beverage. Once the lid has been mounted on the body to complete the enclosure of the beverage, elevated pressure generated by the beverage acts on the inner surface portion of closure member 28 which is exposed through the aperture to the interior of the can, causing the flexible closure member to bulge outwardly. However, the angle θ (FIG. 2) of slope of the flange outer surface relative to the plane of the annular edge 34 (i.e., plane P) is selected to be such that a line tangent to the arc of curvature of the bulged closure member at the inner edge of the flange lies at an angle to plane P not substantially greater than the angle θ of slope of the flange outer surface.

Preferably the angle θ is between about 12.50 and about 40° to the plane P; a more preferred lower limit for θ is about 15°, and a more preferred upper limit is about 35°, or even in some instances about 30°. In currently particularly preferred embodiments, the angle θ of slope is between about 20° and about 35° to the plane P.

After initial forming of the flange there is some spring-back of the metal so that tooling with a 35° forming angle will result (after spring-back) in a flange angle of about 30°. Furthermore, when the can is pressurized, the can end bows and the effective flange angle is further reduced, by an amount which depends on the internal pressure but is typically a few degrees. For burst resistance, it is the actual angle of the flange when the can is pressurized that is relevant (i.e., after spring-back and the bowing of the can end are taken into account) and not the angle of the forming tool.

In FIG. 2, A is the diameter of the aperture 24 in plane P, R is the radius of curvature of the bulged or domed closure member 28, and h is the maximum vertical height of the domed closure member above the aperture plane P. In the figure, the foil closure is shown domed to the point at which the flange is tangential to the arc of the domed foil closure member 28, i.e., at which the line of slope of the flange surface 32 as seen in a vertical plane is tangent to the arc of curvature of the closure 28 (as seen in the same vertical plane) at the edge of aperture 24.

For the closure configuration illustrated in FIG. 2, the forces acting on the heat sealed flange area due to the tension in the foil are predominantly shear in character, with no significant peel force component. In this case, the burst resistance will depend on the shear strength of the heat seal joint or the bulge strength of the foil or foil laminate itself. This ensures that the burst resistance of the lid is enhanced significantly compared to that of a standard heat sealed container.

Heat seal bonds are strong under shear loading, especially at ambient temperature, and an annular heat seal about 2 mm-3 mm wide is sufficient to resist the anticipated shear forces which result from the internal pressure. If the foil is domed to a lesser extent than shown in FIG. 2, relative to the flange slope angle θ, the foil laminate will tend to hold down the heat seal bond with a corresponding additional enhancement of the burst resistance. If, however, the foil were domed to a greater extent than is shown in FIG. 2, relative to the flange slope angle, a peel force component would arise at the inner edge of the aperture, with an increased likelihood of burst failure.

The aperture-defining flange enables provision of a flange slope angle θ sufficient to accommodate the extent of doming or bulging of the closure member to be used therewith, under the elevated internal pressures for which the can is designed, and thereby enables the burst resistance to be enhanced significantly, for a closure with a peel force which is acceptable to the consumer. The peel force is dependent both on the inherent peel properties of the selected heat seal lacquer system, and on geometric effects associated with the complex bending and distortion which the closure foil undergoes during peeling.

As will therefore be clear, the flange slope angle and the form of the foil closure strongly influence the burst resistance. In addition to the flange slope angle and extent of doming of the closure, not only the resistance of the heat seal bond to shear forces but also the strength of the foil of the closure member are selected to withstand the forces acting thereon. If the flange slope angle is such as to substantially avoid any substantial peel force component of forces acting on the heat sealed area owing to tension in the foil from the internal pressure acting on the closure member, and if the heat seal bond and the shear resistance of the bond are adequate, burst failure could occur by failure of the foil itself. The shear force required to break the heat seal bond can be adjusted either by increasing the width of the heat sealed region, or by selecting laminates or coating formulations which achieve a higher shear strength. Both of these expedients, however, would increase the peel force required to open the container.

The effect of heat sealing the closure member 28 to a sloping flange surface rather than a horizontal flange surface, will be apparent from a comparison of FIGS. 3 and 4. FIG. 3 represents an aperture 40 in a conventional lid member 41 wherein the flange 42 around the aperture is simply a flat horizontal portion of the lid upper surface, coplanar with the aperture edge 43. A flexible closure member 44 covering the aperture 40 and bonded by heat sealing to the coplanar flange 42 will bulge, in the same manner as the closure member 28 in FIG. 2, if the lid member 41 is mounted on a can body filled with a carbonated beverage or other pressure-generating contents. Assuming that equal elevated pressures exist within the cans of FIGS. 2 and 3, that the diameters of apertures 24 and 40 are equal, and that the same flexible sheet material is used for the closure members 28 and 44, the extent of bulging of the closure members (defined by h and R) should be essentially identical in both cans. In the case of the planar flange of FIG. 3, the consequent tension force F_{T} acting on the heat-seal-bonded portion of the closure member 44 at the edge of the aperture 40 will have a substantial peeling force component F_{P} acting at 90° to the plane of the flange surface. In the case of the sloping flange, however, as shown in FIG. 4, owing to the above-described relation of angle θ to the angle of the tangent to the arc of curvature of the domed closure member 28 at the aperture edge 34 (in which, in FIG. 4, the reverse curl is omitted for simplicity of illustration), the same tension force F_{T} (which acts in the direction of the aforementioned tangent at the edge of the aperture) has no significant peeling force component F_{P} acting in direction D at 90° to the plane of the (sloping) flange surface 32.

Under the pressures that may obtain within a can of carbonated beverage, the peeling force component F_{P} acting on a flange that is coplanar with the aperture edge can be sufficient to cause the closure member to progressively separate from the flange by peeling until it bursts open, at least if the strength of the heat seal bond is within conventional limits as desired for ease of peeling by a user. The sloping of the flange prevents this from happening, and thereby increases the burst resistance of the heat-sealed closure member sufficiently to enable its safe use on a carbonated beverage can without having to increase the heat seal bond strength to a point which would make the closure member difficult to remove by a user.

It will be understood that the extent of bulging of the closure member under the influence of pressure within the can, and thus the angle of the tangent (relative to plane P) to the bulged or domed closure member at the aperture edge, is dependent on the pressure within the can and the elastic deformability of the closure member. Desirably, the slope angle θ of the, flange surface 32 should be chosen to be sufficiently large so as to be compatible with the bulging characteristic of the chosen closure member material. The provision of the flange, which serves as a seat for the heat sealing of the closure member, as a sloping projection from a (preferably substantially flat) upper surface of a substantially rigid lid, facilitates this provision of a relatively large slope angle. At the same time, by making the aperture area a minor fraction of the total area of the can open end, the height h of the domed closure may readily be kept sufficiently small to be accommodated between the lid of one can and the concave bottom of another when the cans are stacked vertically.

Further, it will be understood that the benefits of the flange and peelable closure may be realized even if the flexible closure member bulges slightly beyond the ideal limit of tangency to the slope of the flange. In such a case, the peel component of force will start to grow, but may still be insufficient to cause failure of the bond.

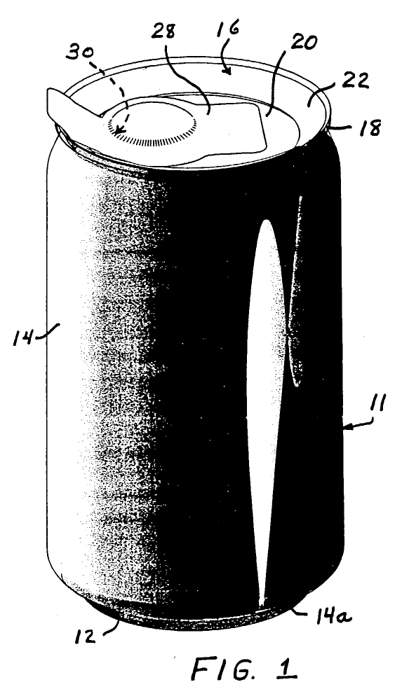

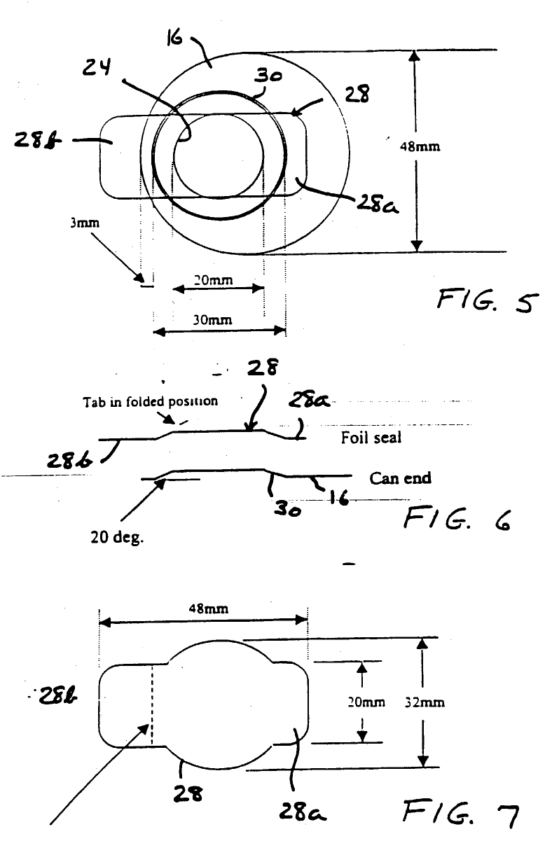

FIGS. 5-7 illustrate further the configuration and arrangement of the flange, aperture and closure member at the top of the can of FIG. 1. With a circular can lid member 16 having a diameter of 48 mm, mountable on a can body having a correspondingly dimensioned circular open upper end, a circular aperture 24 having a diameter of 20 mm is defined by a frustoconical annular flange 30 having a maximum diameter (in the plane of lid surface 20) of 30 mm. As best seen in FIG. 7, the foil-polymer laminate closure member 28 has a circular central portion 32 mm in diameter (large enough to completely overlie the sloping outer surface of the flange), with a short projection 28a on one side for overlying part of the flat upper surface of the lid and an integral tab portion 28b on the opposite side which, outwardly of the flange 30, is not heat sealed but is free to be bent and pulled. The exploded diagrammatic elevational view of FIG. 6 indicates the relative positions of the can lid 16 and the closure member 28, as well as the folding of the tab. The closure member is subjected to a preliminary forming step to impart a frustoconical shape (also indicated in FIG. 6) to its circular central portion for proper seating on and sealing to the flange 30.

The aperture 24 is shown in FIG. 5 as being disposed eccentrically of the geometric center (center of symmetry) of the can lid 16, i.e., relatively close to the edge of the lid, so that a user can easily bring the aperture to his or her mouth for drinking the contained beverage directly from the can. However, depending on use and contents, different positions for the aperture may be employed. Also, if desired, aperture configurations other than the circular shape shown may be provided.

The manufacture of the can of FIG. 1, including particularly the lid and closure, may (as stated) be in many respects generally conventional. However, certain modifications of conventional practice and equipment, now to be described, are employed to achieve the flange shape and the heat sealing of the closure member thereto.

Illustratively, the foil closure stock may be a suitable aluminum foil (e.g. made of alloy AA3104 or of a conventional foil alloy such as AA3003, 8011, 8111, 1100, 1200) with a foil gauge of 0.002″-0.004″ (≈50 μm to 100 μm) which is either lacquered on one side with a suitable heat sealable lacquer, or laminated on one side with a suitable heat sealable polymer film (e.g., polyethylene, polypropylene, etc.), 0.001″-0.002″ (≈25 μm to 50 μm) thick. The other (outwardly exposed) side should have a suitable protective lacquer coating. It may be desirable to print onto the foil using rotogravure, flexographic or another known printing method. It may also be desirable to emboss the laminate, or just the pull tab portion thereof, to provide an attractive surface texture which enhances the appearance of the closure and assists in opening by making the closure easier to grip.

In order to seal to the aperture, the closure members 28 with their described integral pull tabs are formed and stamped out from the foil laminate stock using a suitable press (standard presses can be used with tooling specifically designed for these closure members). In the embodiment where the frustoconical flange is preformed, the foil closure members are preshaped (by a drawing process) so that they will fit over the raised aperture of the lid.

A heat sealing machine with suitable tooling is used to heat seal the closures to the can lid. In the case where the frustoconical flange is preformed, the heat seal tooling is designed to conform to the flange shape. That is to say, the tooling is angled to match the flange (and the formed closure member). The exact heat sealing conditions are dependent on the polymer and heat seal coating formulation used. The temperature of the bottom heat sealing tool should be selected so that the coating on the inside of the lid member should not be significantly softened or melted during the heat sealing operation. For the commonly used can end coatings and for heat seal dwell times of about 0.3 sec. or less, the temperature should be less than about 220° C. and preferably about 200° C. or below. The upper tool temperature is set to ensure that the heat seal bond is achieved in an acceptably short time. Typical commercial heat sealing machines have dwell times of 0.3 sec. The dwell time, pressure and temperatures may be optimized for the particular heat seal application. Heat sealing the closure to the lid involves use of a customized heat sealing line (such as those built by Hans Rychiger AG, Steffisburg, Switzerland), with appropriately constructed heat seal tooling provided to bond the closure to the angled aperture.

The forming of the can lid member 16 itself with the frustoconical flange 30 and aperture 24 as described is relatively straightforward, using modified can end forming tooling, with provision for forming the reverse curl bead 36. The can lids of the invention do not require the formation of a rivet or tab.

The lids, complete with heat sealed closures, are substantially compatible with existing can filling lines and are a direct replacement for the heretofore commercially used lids for cans for carbonated beverages and the like. Modifications may be made in the lid handling equipment to minimize or eliminate the possibility of damaging the raised aperture and closure.

Alternatively, the can lid may initially be provided with the aperture 28 and reverse curl bead 36 around the edge thereof, and the closure member 28 may be heat sealed to the upper surface of the lid in covering relation to the aperture, before the upwardly sloping frustoconical configuration is imparted to the flange portion of the lid immediately surrounding the aperture. Forming of the frustoconical flange 30 then proceeds, with concomitant deformation of the already heat sealed foil closure member, followed by mounting of the lid on a can body already filled with carbonated beverage.

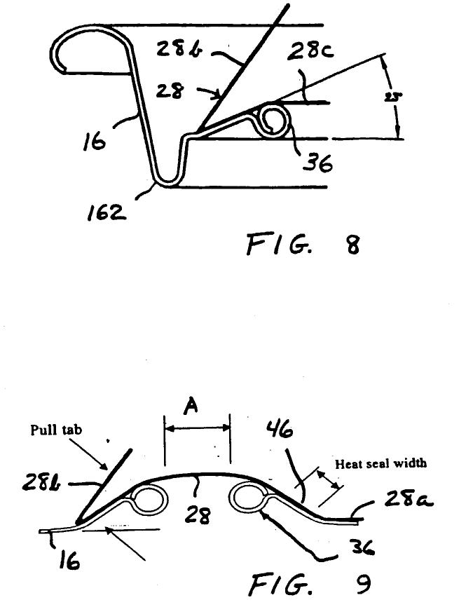

As initially applied to the can lid, the portion of the closure member 28 extending across the aperture may be substantially planar as indicated at 28c in FIG. 8, which shows a frustoconical flange 30 having an angle of slope θ of 23°. When the lid is mounted on a can body filled with a carbonated beverage, so as to completely enclose the beverage, the resultant pressure within the can creates a positive differential pressure Δ_{P} causing the deformable closure member to bulge upwardly. FIG. 9 illustrates the location of the heat seal annulus 46 on the sloping outer surface of the frustoconical flange 30.

A particular feature of the present invention is the dimension of the aperture 24. There is a consumer preference for cans with good pouring characteristics (good pour rate with a smooth, streamlined flow). Cans with large opening ends (LOEs) have been introduced in recent years and have been successful, especially for beverages with lower carbonation levels (e.g. lemonade and iced tea), although in the case of highly carbonated beverages, problems with score line failure and burst resistance have been encountered. A conventional shape of apertures for beverage cans is approximately oval with an aspect ratio between about 1.1 and about 1.5. A standard aperture is 0.7 inch in diameter and an LOE is 1 inch×0.7 inch; thus, the current aperture size for a carbonated beverage container, expressed as average diameter, is from about 0.7 inch to about 0.875 inch.

The tear/shear forces acting on the closure member and seal tend to increase with aperture size, so that the maximum aperture diameter is limited by the need to provide a can with adequately high burst pressure or burst resistance (i.e., the pressure at which the closure member and seal rupture or fail). Therefore, the range of average aperture diameter is between about 0.625 inch and about 1 inch, to afford satisfactory pour rates (without any separate vent hole) and at the same time to achieve high burst resistance without sacrifice of other characteristics such as peelability.

Another important characteristic, for attainment of adequately high burst resistance, is the tear/shear force imposed on the heat seal and closure member by a given differential pressure. The tear/shear force γ (lb./in.) is determined by the differential pressure Δₚ (psi), aperture diameter A (inches) and angle of slope θ of the frustoconical flange 30, in accordance with the relation

$$γ = \frac{A \cdot {Δ}_{P}}{4 sin Θ} \qquad ( 1 )$$

In particular instances, depending (for example) on the degree of carbonation of the contained beverage and the consequent magnitude of differential pressure that the can, closure and seal must be designed to withstand, the design value of tear/shear force resistance for a can in accordance with the invention (i.e., the value that the closure member and heat seal must be able to withstand) may range from less than (or about) 25 lb./in. to about (or even somewhat more than) 75 lb./in., a tear/shear resistance of about 75 lb./in. being currently preferred in many cases. Typical filling line pressures for carbonated beverages are between about 50 and about 60 psi, though for some beverages (sports drinks, lemonade, etc.), lower carbonation levels are used. However, in order to take account of extreme conditions (temperature, agitation, etc.) a minimum test burst pressure requirement of 90 psi is currently specified for many applications, and a burst resistance of 100 psi would be even more desirable.

By way of illustration, an aperture diameter of 0.875 inch and a flange angle of about 22.50 would require a closure foil with a breaking strength in excess of 57.2 lb./in. and an equivalent minimum heat seal shear strength, for burst resistance of 100 psi.

Typical aluminum lidding foils of 0.003 inch thickness can withstand a tear force in excess of 75 lb./in. Practicable heat seals capable of withstanding a shear force of 75 lb./in. can also readily be provided, in configurations suitable for the heat seal 46.

Metal foils have comparatively good creep resistance over the range of temperatures that may be experienced in service, and therefore afford an important advantage over polymeric closure member materials with respect to creep susceptibility and consequent short shelf life. Since creep is dependent on applied stress, increasing the thickness of the closure material can reduce or eliminate creep. For aluminum foil closure members, a thickness between about 0.003 and about 0.004 inch (about 75-100 μm) is sufficient to virtually eliminate creep.

The performance of the bond between the closure membrane and the lid flange is dependent on the properties of the adhesive layer and on the design of the joint. The flange angle is designed to ensure that the forces between the closure membrane and the flange are predominantly shear in character under the fully pressurized conditions of use. However, the shear stress in the joint can be affected by the width of the heat seal; i.e., increasing the width of the bond spreads the load and thereby reduces the stress intensity.

It is desirable for the width of the heat seal to be less than about 0.118 inch (3 mm) and preferably about 0.079 inch (2 mm). If the width is increased above about 0.118 inch (3 mm), the peel force required to open the container will be increased. Furthermore, an increased heat seal (and flange) width would mean that the drinking aperture has to be located further from the container edge, detracting from the convenience of the consumer by making the container less comfortable and more inconvenient to drink from.

Experimentally, it is found that a 0.079 inch (2 mm) wide heat seal annulus for the foil closure performs well in the can of the invention (for example). Fully pressurized cans (60-70 psi) have been stored at ambient temperature (≈20° C.) for several months, with no detectable sign of creep in either the foil or in the adhesive bond joint.

In containers for beverages and the like with manually peelable closures, the peel force required to open the container should preferably be in a range between about 1.8 lb. and 4.5 lb. (8N and 20N), and more preferably in a range between about 2.25 lb. and 3.6 lb. (10N and 16N) as measured by a 90° peel test. The peel force required is dependent on the peel strength of the bond and on the effective width of the seal during the peeling procedure. In the case of an angled flange, there is also a geometrical factor, which affects the final peel force required. The strength and gauge of the foil also contribute to peel strength since the peel action requires the foil to be bent and deformed.

In the case of heat seal bonding, the peel strength is influenced by the particular lacquer formulations on the two mating surfaces, and on the heat sealing conditions which are used. For example, in one suitable structure the outer can end panel surface has a thin vinyl lacquer coating (Valspar Unicoat, up to about 2 μm thick) and the aluminum foil closure material has a vinyl based heat seal lacquer (Alcan Rorschach TH388, between about 5 and 8 μm thick). For this combination of coatings, the peel strength falls within an acceptable range for peelability; at the same time, provided the closure foil has sufficient strength, the heat seal bond can meet the requirements for shear strength. Variations in peel strength can be obtained by changes to the heat sealing temperature, the heat sealing pressure and/or the dwell time for sealing.

In addition to vinyl based lacquer systems, various other combinations of can end lacquer and heat seal coatings have been found to be suitable for the present invention.

The can described above is, as stated, of the same type and construction as cans described in the aforementioned copending application Ser. No. 10/150,683; its contents (e.g. a carbonated beverage) may be entirely conventional. In accordance with the present invention, and as a particular feature thereof, the peelable closure member 28 of the can includes a portion that undergoes an irreversible change in appearance upon bending by peeling of said closure member.

More particularly, in currently preferred embodiments of the invention, the appearance-changing portion of the closure member 28 is a color change device of a type described in the aforementioned U.S. Pat. No. 5,282,650. Such a device can be made by a process that involves anodizing a color generating metal, such as a valve metal (e.g. Ta, Nb, Zr, Hf and Ti), a refractory metal (e.g. W, V and Mo), a grey transition metal (e.g. Ni, Fe and Cr), a semi-metal (e.g. Bi) or a semiconductor metal (e.g. Si), in order to form an anodic film of oxide having a thickness in the order of the wavelength of light (an “optically thin” film) intimately contacting the color generating metal. The resulting laminates exhibit a strong interference color when illuminated with white light because of light interference effects between reflections from the closely spaced metal and oxide surfaces and because of light absorption which takes place at the metal/oxide interface when color generating metals are employed.

The anodization is carried out in an electrolyte containing an adhesion reducing agent, such as a fluoride, which lowers the normally tenacious adhesion of the oxide film to the metal substrate. This allows the oxide film to be detached from the substrate with consequent destruction or modification of the exhibited color. Reattachment of the oxide layer does not result in regeneration of the original color, so the color change is essentially irreversible and forms an effective indication of tampering. The adhesion-reducing agent is present at a concentration which results, at the anodizing voltage, in the formation of the anodic film in such a way that the generated color is changed when the substrate and attached anodic film undergo bending.

Thereby there is provided a color change device comprising a flexible substrate comprising a color generating metal at a first surface, and an optically thin anodic film on the color generating metal intimately contacting the first surface of the substrate and generating an interference color, the device having at least one area in which the interference color can be changed by bending the flexible substrate.

The term “color-generating metal” as used herein means a metal capable of generating a color different from its normal color when covered by an intimately contacting optically thin layer of transparent material, i.e., a layer having a thickness in the order of the wavelength of light suitable to generate optical interference effects.

The device preferably has a layer of transparent or translucent material adhering to the anodic film in order to protect the delicate film from damage by scratching, etc., and to assist the color change effect which takes place upon bending of the device. The transparent or translucent material is preferably a plastic or polymer sheet attached to the anodic film by means of an adhesive or by other means such as heat sealing. In some cases the sheet may be made friable so that it disintegrates when bending takes place and provides further evidence of tempering.

The use of concentrations of adhesion-reducing agents from narrowly defined ranges during the anodization step leads to devices which can be activated by bending. The effective concentrations depend not only on the nature of the adhesion-reducing agent and the color-generating metal, but also to some extent on the thickness of the anodic film which is, in turn, governed by the anodization voltage (and possibly the anodization time). In general, the use of higher anodization voltages for the preparation of the device requires lower concentrations of the adhesion-reducing agent to produce devices of equal susceptability of activation by bending.

Additionally, the triggering of the change of color in the devices of the invention depends not only on the inherent sensitivity of the device to activation by bending, which is governed by the concentration of the adhesion-reducing agent and the voltage used for the formation of the device as indicated above, but also on the radius of curvature through which the device is bent or fixed, which in turn depends on such factors as the stiffness and strength of attachment of the device.

Consequently, in order to produce effective color change devices it is often necessary to balance or optimize at least the concentration of the adhesion-reducing agent used for the preparation of the device with the effective range of the anodization voltage (and possibly time), the stiffness of the finished device and the strength of attachment of the device to the article to be protected, so that activation inevitably takes place when tampering is attempted, but not before.

The preferred adhesion-reducing agent is a fluorine-containing compound, most preferably a fluoride. The fluorine-containing compounds may be used in the form of aqueous solutions of simple salts, e.g. NaF or KF, complex salts, or acids such as hydrofluoric acid, fluoroboric acid, etc.

In the case of tantalum, the effective concentration of F⁻ is usually in the range of 40-90 ppm in the anodizing electrolyte. When the color generating metal is niobium, a concentration of fluoride in the range of 150-350 ppm produces good color loss activation upon bending.

Sensitivity to activation depends to some extent on the overall stiffness of the device, which is mainly governed by the thickness of the overlying transparent or translucent layers in cases where the color-generating metal substrate is a very flexible thin foil of 10 μm in thickness or less. Tests have shown that good results are achieved in such cases when the thickness of any overlying transparent or translucent polymer layer is about 125 μm.

The color generating substrate commonly comprises a very thin (usually sputtered) layer of the color-generating metal on a thin foil of inexpensive metal, such as aluminum. Such a structure makes it possible to minimize the quantity of the expensive color-generating metal required for the fabrication of the device. In some cases, the aluminum foil may itself be supported on a sheet of plastic, in which case the stiffness of this additional plastic sheet should of course be taken into account when estimating the overall stiffness of the device.

A typical device of the above kind having suitable flexibility consists of a metal foil of about 7 μm in thickness supported on an underlayer of polyester sheet of about 50 μm and covered by a second transparent polyester sheet of about 12.5 μm in thickness.

The devices are normally bent during activation into curves having the anodic oxide film on the inside of the curve because the anodic film must generally be outermost for the color to be generated. However, a color change is usually also produced if the device is bent through a curve having the anodic film on the outside although it is observed that the sensitivity of the device may then be somewhat reduced.

These color change devices may incorporate “latent indicia”, i.e. messages, patterns or designs which are not visible before the color change is produced, but which become visible when the color change is activated. Such devices are produced by masking certain areas of the color-generating metal from the effects of the adhesion-reducing agent, at least during the initial stages of the anodization step. As a result, certain parts of the resulting anodic film become activatable while other parts remain substantially incapable of exhibiting a color change, but otherwise the anodic film is identical in all areas of the device. When attempts are made to remove the device from the underlying article, a color change takes place only in certain areas of the device. The resulting areas of contrasting colors form a visible message, pattern or design. When producing devices of this kind, care should be taken to ensure that the concentration of the adhesion-reducing agent is suitable for activation by bending but low enough to prevent premature development of the latent indicia.

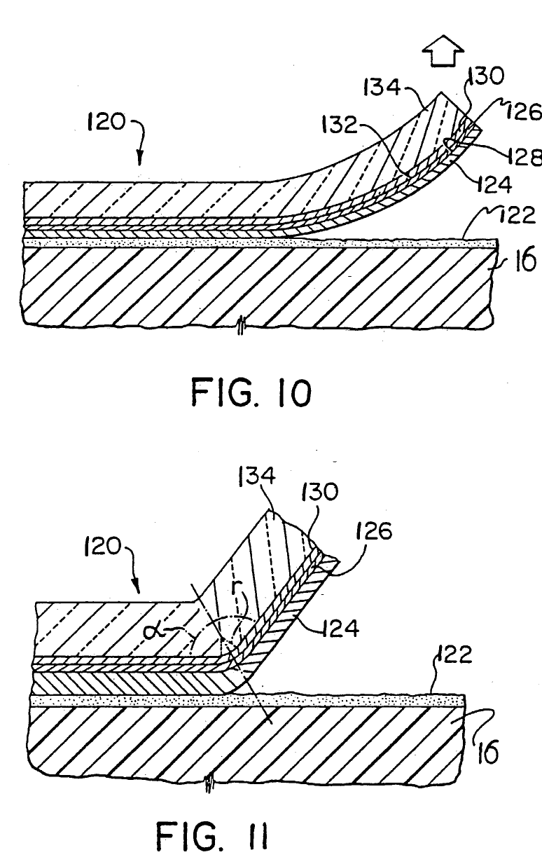

An embodiment of a closure member 28 incorporating such a color change device as a portion thereof is illustrated in FIGS. 10 and 11 which show a lid 16 having the thin flexible closure member incorporating color change device 120 attached to its surface by an adhesive layer 122. The color change device 120 is disposed on, or includes, a flexible aluminum foil 124 (which may be the foil closure member 28) and comprises a thin layer 126 of a color generating metal coating one surface 128 of the foil. The layer 126 of color generating metal has an intimately associated anodic film 130 covering the outer surface 132 thereof formed by anodization in the presence of an adhesion-reducing agent at a concentration suitable for activation of the color change by bending. The entire device 120 is covered by a layer 134 of transparent or translucent material, such as a polymer sheet (preferably heat-sealed to the anodic film 130). As the entire closure member is peeled from the lid 16 from one edge as shown by the arrow in FIG. 10, the inevitable bending causes the originally generated color to be destroyed. If desired, the device may contain latent indicia as indicated above.

FIG. 11 shows the device 120 on a larger scale in the region where the closure member separates from the lid 16. As the closure member separates from the lid, its overall thickness and stiffness usually prevents it from forming a completely sharp angle, but instead it is bent around a short radius of curvature r at the apex of included angle α. The concentration of adhesion-reducing agent used in the formation of the device 120 is sufficient to permit color change activation when r and α are in the range inevitably encountered when peeling of the entire device from the article 110 is attempted.

Although the device 120 of FIGS. 10 and 11 is shown as having the color generating metal directly coated in the foil of the closure member itself, the device may have its own, much thinner aluminum or other metal foil substrate coated with the color generating metal. The substrate of the device is then adherently bonded to the outer surface of the closure member 28. When the color generating metal is directly coated on the foil of the closure member, the coating of the color generating metal together with its intimately associated oxide film constitutes the appearance-changing portion of the closure member. When the color changing device has its own substrate, of foil with or without an underlayer, the appearance changing portion of the closure member includes the latter substrate as well as the color generating metal and the anodic film. As hereinafter further explained, the appearance-changing portion may extend over all or only part of the outer surface of the closure member.

As one example of an alternative appearance-changing portion of the closure member of the present invention, in place of the type of color change device described above there may be provided an interference structure of the type described in the aforementioned U.S. Pat. No. 5,218,472, sometimes referred to as a metal-oxide-metal (MOM) device. Illustratively, such a device may be formed of aluminum foil which is porous anodized so as to produce an anodic film having a weakened, adhesion-tuned stratum and then overcoated (i.e. on the anodic film) with an extremely thin (e.g., 50 Å) semi-transparent layer of a suitable grey metal (e.g. Ni, stainless steel or Ti), typically followed by application of a transparent protective outer layer. Owing to the weakened stratum, part or all of the film can be detached from the remaining structure along this stratum, e.g. by bending. With the stratum suitably located, the interference color generated by the structure can be created, changed or destroyed irreversibly when the upper part of the film is thus detached or delaminated.

Such a weakened stratum can be introduced into the anodic film by a pore-branching technique as set forth in the aforementioned U.S. Pat. No. 5,218,472. In addition, as also there described, messages or patterns can be incorporated into the interference structure having a weakened stratum by reinforcing the pores in some areas of the device while leaving the pores in other areas unchanged, so that the upper film part can be detached only in the non-reinforced areas.

As in the case of the first type of color change device described above, a device of this MOM type can be formed on or (if produced on its own foil substrate) adhered to the outer surface of the foil closure member 28 of the beverage package of the invention to constitute the appearance-changing portion thereof.

With either of the abovedescribed types of appearance changing portion, the bending of the closure member that occurs incident to peeling the closure member to open the aperture of the beverage package causes an irreversible delamination and, concomitantly, an irreversible change in color either of the entire appearance changing portion or of selected parts thereof which form a legend, pattern or design that appears only upon such bending.

As a further alternative, the closure member 28, including the appearance-changing portion (with or without a protective outer coating layer) disposed on its outer (upper) surface, is itself covered with a clear pressure-sensitive label having a protruding or graspable tab. The closure member and clear label are so arranged that, to open the aperture of the can, the clear label must be peeled off before the closure member is peeled off. Such preliminary peeling of the clear label effects irreversible, color-changing delamination of the appearance changing portion of the closure member, either over the whole area of that portion or in a pattern (created by patterned distribution of weakened areas, as described above) to reveal a previously undetectable message, logo or other design.

The appearance changing portion (with or without a clear overlying label), in any of the foregoing embodiments, may conveniently be applied to the outer surface of the closure member 28 before the closure member is bonded to the lid 16 to cover the aperture. As described above, the closure member is preformed to fit over the flanged aperture of the lid, or the aperture-surrounding flange of the lid is formed after the closure member is already bonded thereto; in either case, the closure member is subjected to bending distortion or deformation. Moreover, when the lid is subsequently secured to the can body filled with carbonated beverage, the closure member is subjected to the elevated pressure within the can and is thereby caused to bulge upwardly, again undergoing distortion. Such distortion (i.e., incident to forming operations and/or subjection to internal pressure) can prematurely activate the appearance-changing portion of the closure member. Such premature change in color or appearance is undesirable, because the intent of providing the appearance-changing portion is that the change in appearance be activated only upon bending the closure member to open the aperture.

As will be appreciated, the distortion or deformation of the closure member incident to closing and pressurization does not occur uniformly over the entire outer surface of the closure member but selectively in one or more areas thereof (hereinafter collectively referred to as a first region of the closure member) while other areas of the closure member (hereinafter collectively referred to as a second region of the closure member) undergo substantially less, or no, distortion. Thus, premature activation of the appearance-changing portion of the closure member is liable to occur only insofar as the appearance-changing portion is located in the first region of the closure member.

In accordance with the invention, premature activation (or at least the consequence of a premature visible change in appearance of the closure member) is prevented. For instance, if the distortion to which the first region of the closure member is subjected during forming and/or pressurization is substantially less severe than that occasioned by bending of the closure member upon peeling, the concentration of adhesion-reducing agent and the anodization voltage employed in the preparation of the color change device 120 may be mutually selected to provide a sensitivity such that the device undergoes color-changing delamination only when subjected to the more severe distortion exerted by bending upon peeling of the closure member, and withstands the lesser distortion produced by forming and/or pressurization.

Alternatively, the appearance changing portion may be disposed only in the second region and not in the first region of the closure member, so as not to be subjected to the distortion produced in the first region by forming and/or pressurization. Stated with reference to the device 120 of FIGS. 10 and 11, for example, the coating of color generating metal (with its associated anodic film), whether directly coating the foil of the closure member or coating a discrete substrate foil which is adhered to the closure member, is placed on all or part of the second region of the closure member but omitted entirely from the first region. As a modification of this arrangement, the color generating metal with its anodic film may extend over the entire area of the closure member surface, but with selective masking (during production) of the effect of the adhesion-reducing agent so that the latter agent is effective (i.e., to create a weakened stratum) only in areas corresponding positionally to the second region of the closure member. Illustratively, where such masking is also designed to provide an initially latent message or pattern, the masking is so disposed that the message-revealing delamination occurs only in the second region of the closure member.

As yet another alternative, the appearance-changing portion may extend over the entire surface of the closure member, but may be selectively concealed, in the first region of the closure member, by an overprint of ink or the like, in such manner that any prematurely activated appearance change in the first region is hidden by the overprint, while the appearance changing portion is visible (to indicate peeling) in the second region of the closure member. The closure member is commonly overprinted with ink in any event; hence, use of a printed overlay to conceal areas of the color change device vulnerable to premature activation may in many instances be more simple and convenient than selective application of a color change device to particular areas of a closure member.

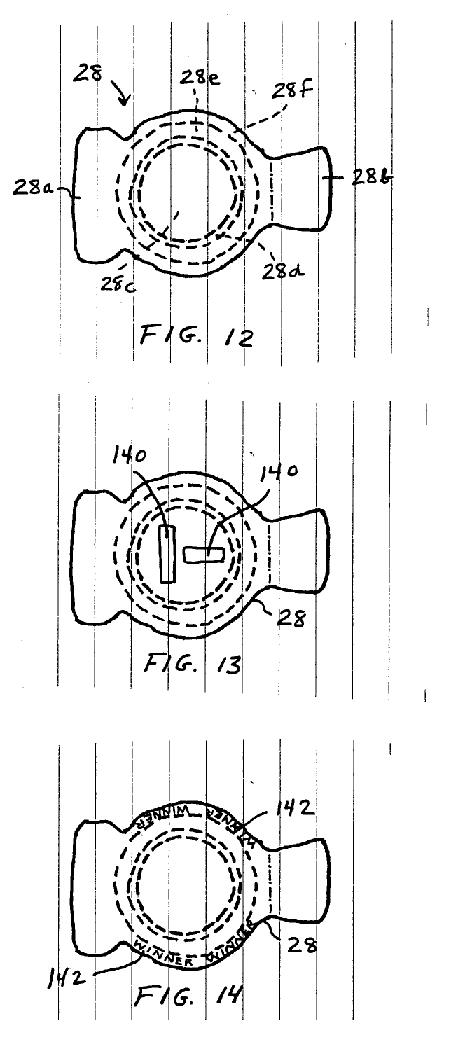

The areas of the closure member upper surface in which the appearance-changing portion should or should not be present and/or visible may be explained with reference to FIG. 12, which is a plan view of a typical closure member 28 (of the same type as in FIGS. 1-9) having a projection 28a overlying and adhered to a flat portion of the lid surface, a free tab portion 28b serving as a graspable pull tab on an opposite side of the closure member from portion 28a, a central portion 28c directly overlying the lid aperture (which is circular in the illustrated embodiment), a circular portion 28d overlying the curled bead (36 in FIG. 2) around the aperture, another, concentric circular portion 28e overlying the upwardly sloping flange (30 in FIG. 2) formed in the lid, and a further portion 28f overlying the flat lid in concentrically surrounding relation to the flange. The adhesion or heat seal area is the above described annular region 46 (FIG. 9) where the closure member is bonded to the sloping flange surface, and also at least part of the area of projection 28a; all other parts of the closure member are not adhered. When the closure member is peeled from the lid to open the aperture, it separates completely from region 46 but may remain bonded to the lid at projection 28a.

The areas of the closure member in which a color change member may be vulnerable to premature activation by forming and/or pressurization may vary depending on the particular design, dimension, and internal method of a specific product (beverage package). Thus, in some instances, premature delamination and consequent color change activation may be liable to occur only at the base of the flange. In other products, premature activation may be liable to occur only in the portion 28c that directly overlies the aperture and is subjected to upward bulging upon pressurization. The location of the areas liable to premature activation (the first region of the closure member), where the appearance-changing portion should be omitted or concealed by an overprint, for any specific product, may be readily be determined by simple tests.

Ordinarily, the appearance-changing portion should be omitted from or concealed in the pull tab 28b, because it might accidentally be activated by bending of the tab alone without peeling of the closure member from the lid.

An example of dimensions for a closure member covering a circular aperture, in which the radius of the outer limit of portion 28c is about 0.403 inch and the radius of the outer limit of portion 28e is about 0.570 inch, is as follows:

| | |
|---|---|
| Total area of closure member | 2.2809 in² |
| Area of pull tab 28b | 0.4731 in² |
| Area of portion 28c | 0.5100 in² |
| Area of portions 28d and e | 0.5090 in² |

In this example, the area of the portion of the closure member covering the flange and curled bead is about 23% of the total area of the closure member, and the area of the portion of the closure member covering the aperture, together with the area of the pull tab, is about 44.5% of the total closure member area.

A currently preferred range of total area of the closure member in which the appearance-changing portion is present and/or visible (i.e., if partly masked by an overprint) is about 15 to about 75%, more preferably about 35 to about 55%.

In other embodiments of the invention, as shown in FIG. 13, the appearance changing portion of the closure member, e.g. a color change device of the type illustrated in FIG. 10, is formed on its own thin foil substrate to constitute a flexible web material, and is adherently applied (for instance, as one or plural strips 140) to the outer surface of the closure member 28 only after the lid has been secured to the can body, i.e., only after the closure member has fully undergone the deformation or distortion that occurs incident to forming and pressurization. Consequently, the appearance-changing portion is not subjected to such distortion or deformation, and no premature activation can take place, and there is no need to restrict the location and/or visibility of the appearance-changing portion to the aforementioned second region of the closure member. When the closure member is peeled from the can, the strip or strips 140 undergo color-changing delamination, either over their entire area or selectively in message-forming or pattern-forming parts thereof.

Conveniently, the strips 140 may be applied to the closure member as the filled and closed cans of carbonated beverage or the like come off the filling line. Since they may be located on any part of the closure member that bends upon peeling from the lid, they can be placed at the most desirable location from the standpoint of visibility and their total area may be minimized to reduce cost. Currently it is preferred that the strip or strips 140 cover, in total, about 5 to about 50% (more preferably, about 15 to about 35%) of the total outer surface area of a closure member 28.

Typically, the appearance-changing portion of the closure member (or such part as is not concealed by an overprint) will exhibit a uniform color before peeling of the closure member from the can lid. When subjected to bending upon peeling, whatever part of the appearance-changing portion undergoes delamination will change to a metallic color that is clearly visually distinguishable from the original color. If delamination occurs selectively so as to reveal a message, pattern or design, the original color will remain in the non-delamination areas while the delaminated areas change to the metallic color.

The appearance-changing portion of the described closure members may function as a tamper-evident feature on a beverage package, serving to indicate (by simple uniform color change, or by appearance of an initially latent legend or pattern) that the closure member has been at least partially peeled from the aperture.

In a further important aspect of the invention, the appearance-changing portion serves a promotional function, in particular to designate winners of promotional contests. To this end, one or a small number of cans with a hidden closure legend such as “WINNER” (as indicated at 142 on the closure member 28 shown in FIG. 14) that appears only on peeling the closure are provided and seeded among a much larger number of cans lacking that legend, the purchaser of the “WINNER” can being entitled to claim a prize. In such a contest, the closures of all cans have an identical initial color and appearance before peeling. Very advantageously, non-winning cans are also provided with appearance-changing features activated by peeling, that either bear a different legend or design or merely exhibit a uniform color change with no legend. By imparting a peeling-activated appearance change to the closures of all cans involved in a promotional contest, with a differentiation in design or legend for the winning can(s), the appearance-changing feature is able to serve a tamper-indicating purpose as well as functioning to identify the winner or winners of the contest. The invention in this aspect is in a broad sense not only applicable to cans with pressurized contents, but may be embodied in cans and containers with peelable closure members for a wide variety of beverages and other contents, regardless of whether the closure member is subjected to any distortion or deformation before peeling.

A method of conducting a promotional contest in accordance with the invention to determine, from among a number of individuals, a winner or winners of the contest, comprises steps of providing a group of packages each having an aperture closed by a peelable closure member including a portion that undergoes an irreversible change in appearance upon bending, the group comprising at least one package having a first type of closure member and a plurality of packages having a second type of closure member, the first and second types of closure members being indistinguishable from each other before bending but visibly different in appearance from each other after bending, wherein the appearance of the first type of closure member after bending designates a winner of the contest; distributing packages of the group to different individuals in such manner that distribution of a package having the first type of closure member is a random event; and identifying, as a winner of the contest, an individual who has received a package having the first type of closure member and has peeled the latter closure member thereby changing its appearance. The distributing step may be performed, for example, by disposing the group of packages in an array from which individuals select and manually remove one or more packages, the package or packages with first-type closure members being randomly positioned in the array; or the step may be performed by successively dispensing packages of the group to different individuals.

It is to be understood that the invention is not limited to the features and embodiments hereinabove specifically set forth, but may be carried out in other ways without departure from its spirit.

What is claimed is:

1. A beverage package comprising:
(a) a can including a body having an open upper end and a substantially rigid lid secured at its periphery to and closing said body end, said lid having an upper surface and defining an aperture;
(b) a quantity of a carbonated, or otherwise pressurized, beverage contained within said can; and
(c) a flexible closure member extending entirely over said aperture and peelably bonded to said lid upper surface entirely around said aperture;
wherein the improvement comprises:
(d) said closure member including a portion that undergoes an irreversible change in appearance upon bending by peeling of said closure member.

2. A package as defined in claim 1, produced by successive steps of applying and bonding the closure member to the lid upper surface, filling the can body with the beverage and then closing the open upper end of the can body by securing the lid thereto with the closure member already bonded to the upper surface, wherein a first region of the closure member undergoes distortion during performance of said steps while a second region of the closure member undergoes at least substantially less distortion than said first region.

3. A package as defined in claim 2, wherein said portion is provided in said closure member before said lid is secured to said body but does not undergo any observable change in appearance upon distortion of the closure member as aforesaid.

4. A package as defined in claim 3, wherein said portion is disposed in at least part of said second region but not in said first region.

5. A package as defined in claim 4, wherein said closure member has an upwardly facing surface area and said portion covers between about 15% and about 75% of said area.

6. A package as defined in claim 5, wherein said portion covers between about 35% and about 55% of said area.

7. A package as defined in claim 3, wherein said portion is disposed in both said first and second regions, and said closure member further includes a printed overlay masking said portion in said first region but not in said second region, thereby to conceal any change in appearance of said portion in said first region.

8. A package as defined in claim 2, wherein said portion is added to said closure member after said lid is secured to said body.

9. A package as defined in claim 8, wherein said portion comprises flexible web material adherently applied to at least part of said closure member.

10. A package as defined in claim 9, wherein said closure member has an upwardly facing surface area and said portion covers between about 5% and about 50% of said area.

11. A package as defined in claim 10, wherein said portion covers between about 15% and about 35% of said area.

12. A package as defined in claim 9, wherein said closure member comprises at least two separate strips of said flexible web material.

13. A package as defined in claim 1, wherein said portion comprises a flexible substrate comprising a color generating metal at a first surface and an optically thin anodic film on said color generating metal intimately contacting said first surface of said substrate and generating an interference color, said portion having at least one area of said first surface in which said anodic film is attached to said color generating metal with a strength of attachment falling within a range allowing said interference color to be changed in said at least one area by bending said portion.

14. A package as defined in claim 13, wherein said anodic layer is covered by a flexible layer of transparent or translucent material and said color generating metal is selected from the group consisting of tantalum and niobium.

15. A package as defined in claim 1, wherein said portion comprises an optical interference structure which comprises a reflective substrate, a porous dielectric film on said reflective substrate and having an outer surface opposite thereto, at least one semi-transparent reflective layer supported by said porous dielectric film, said structure having at least two reflective surfaces separated by an optically thin porous layer of said dielectric film, one of said surfaces being present at said outer surface of said film, and said structure having a weakened stratum in said porous film between said outer surface and said substrate, the position of said stratum being such that, upon separation of said film along said stratum, a change of color is observed.

16. A package as defined in claim 1, wherein said portion comprises at least two contiguous layers, one overlying the other, and is characterized by a first apparent color that changes irreversibly to a second color, visually distinguishable from the first color, upon separation of the layers; and wherein said layers, in at least part of said portion, separate upon bending of the closure member.

17. A package as defined in claim 16, wherein said portion further comprises an agent that alters the resistance of said contiguous layers to separation.

18. A package as defined in claim 17, wherein said agent is provided in a pattern such that upon bending, the contiguous layers separate, to produce a change from the first color to the second color, in accordance with said pattern, thereby making said pattern visible.

19. A package as defined in claim 1, wherein said portion comprises at least two contiguous but separable layers, one overlying the other, and is characterized by a first apparent color that changes irreversibly to a second color, visually distinguishable from the first color, upon separation of the layers; and wherein the portion further comprises a manually peelable transparent member adherently superposed on the overlying one of said layers such that peeling of the transparent member effects separation of said layers producing a change from the first color to the second color, said closure member being peelable to open said aperture only after peeling of said transparent member.

20. A can comprising:
(a) a metal can body having an open upper end;
(b) a substantially rigid metal can lid secured at its periphery to and closing said can body end, said lid having an upper surface;
(c) an annular flange formed in a portion of said lid and projecting upwardly from said lid upper surface, said flange having an upwardly sloping outer surface and an annular inner edge lying substantially in a plane and defining an aperture; and
(d) a flexible closure member of a material comprising a metal foil, extending entirely over said aperture and peelably bonded by a heat seal to said flange outer surface entirely around said aperture;
wherein the improvement comprises:
(e) said closure member including a portion that undergoes an irreversible change in appearance upon bending, said portion being disposed to be bent by peeling of said closure member.

21. A can lid mountable on a metal can body having an open upper end so as to be secured at its periphery to and to close said can body end, said lid comprising a substantially rigid unitary metal can lid member having an upper surface with an annular flange formed in a portion of said lid and projecting upwardly from said lid upper surface, said flange having an upwardly sloping outer surface and an annular inner edge lying substantially in a plane and defining an aperture; and a flexible metal foil closure member extending entirely over said aperture and peelably bonded by a heat seal to said flange outer surface entirely around said aperture, wherein the improvement comprises:
said closure member including a portion that undergoes an irreversible change in appearance upon bending, said portion being disposed to be bent by peeling of said closure member.

22. A carbonated, or otherwise pressurized, beverage package comprising:
(a) a can including a metal can body having an open upper end and a substantially rigid metal can lid secured at its periphery to and closing said can body end, said lid having an upper surface;
(b) a body of a carbonated, or otherwise pressurized, beverage contained within said can;
(c) an annular flange formed in said lid and projecting upwardly from said lid upper surface, said flange having an upwardly sloping outer surface and an annular inner edge lying substantially in a plane and defining an aperture; and
(d) a flexible metal foil closure member extending entirely over said aperture and peelably bonded by a heat seal to said flange outer surface entirely around said aperture;
wherein the improvement comprises:
(e) said closure member including a portion that undergoes an irreversible change in appearance upon bending, said portion being disposed to be bent by peeling of said closure member.

23. A method of producing a beverage package comprising a can including a body having an open upper end and a substantially rigid lid secured at its periphery to and closing said body end, said lid having an upper surface and defining an aperture; a quantity of a carbonated, or otherwise pressurized, beverage contained within said can; and a flexible closure member extending entirely over said aperture and peelably bonded to said lid upper surface entirely around said aperture; said method comprising successive steps of
(a) applying and bonding the closure member to the lid upper surface,
(b) filling the can body with the beverage and then
(c) closing the open upper end of the can body by securing the lid thereto with the closure member already bonded to the upper surface,
wherein a first region of the closure member undergoes distortion during performance of said steps while a second region of the closure member undergoes at least substantially less distortion than said first region,
wherein the improvement comprises
(d) providing said closure member with a portion that undergoes an irreversible change in appearance upon bending by peeling of said closure member.

24. A method according to claim 23, wherein said portion is provided in said closure member before said lid is secured to said body but does not undergo any observable change in appearance upon distortion of the closure member as aforesaid.

25. A method according to claim 24, wherein said portion is disposed in at least part of said second region but not in said first region.

26. A method according to claim 24, wherein said portion is disposed in both said first and second regions, and said closure member further includes a printed overlay masking said portion in said first region but not in said second region, thereby to conceal any change in appearance of said portion in said first region.

27. A method according to claim 23, wherein said portion is added to said closure member after said lid is secured to said body.

28. A method according to claim 27, wherein said portion comprises flexible web material adherently applied to at least part of said closure member.

29. An array of cans each having an aperture closed by a peelable closure member including a portion that undergoes an irreversible change in appearance upon bending, the array comprising at least two cans respectively having closure members that are indistinguishable from each other before bending and are visibly different in appearance from each other after bending.

30. A method of conducting a promotional contest to determine, from among a number of individuals, a winner or winners of the contest, said method comprising:
(a) providing a group of packages each having an aperture closed by a peelable closure member including a portion that undergoes an irreversible change in appearance upon bending, the group comprising at least one package having a first type of closure member and a plurality of packages having a second type of closure member, said first and second types of closure members being indistinguishable from each other before bending but visibly different in appearance from each other after bending, wherein the appearance of said first type of closure member after bending designates a winner of the contest;
(b) distributing packages of said group to different individuals in such manner that distribution of a package having said first type of closure member is a random event; and
(c) identifying, as a winner of the contest, an individual who has received a package having said first type of closure member and has changed the appearance of the last-mentioned closure member by peeling.

31. A method according to claim 30, wherein each said package is a beverage container.

32. A method according to claim 31, wherein each said beverage container comprising a can for holding a quantity of a beverage.

33. A method according to claim 32, wherein each said can is a can for holding a quantity of a carbonated beverage.

34. A method according to claim 33, wherein each said can has a drinking aperture and the closure member of each can is a peelable foil closure member adhered to the can.

35. A method according to claim 34, wherein the peelable foil closure member includes a free tab portion and an aperture-covering portion.

36. A method according to claim 30, wherein the distributing step comprises disposing the group of packages in an array from which individuals select and manually remove one or more packages, said at least one package being randomly positioned in the array.

37. A method according to claim 30, wherein the distributing step comprises successively dispensing packages of the group to different individuals.
